(19) United States
(12) Patent Application Publication
(10) Pub. No.: US 2015/0026004 A1
(43) Pub. Date: Jan. 22, 2015

(54) Internet System for users to send tangible items to a recipient with just the recipient's email address and without providing the mailing address.

(71) Applicant: Craig Fok, Walnut Creek, CA (US)

(72) Inventor: Craig Fok, Walnut Creek, CA (US)

(21) Appl. No.: 13/943,924

(22) Filed: Jul. 17, 2013

(51) Int. Cl. G06Q 30/06

(52) U.S. Cl. CPC G06Q 30/0633
USPC 705/26.8

(57) ABSTRACT

A computer implemented method and system for the internet user to order items, including gifts and flowers, from a website and to be able to send the order to a recipient without having the user provide the recipient's mailing but only the recipient's email address. After the user submits the order in the website, an email is sent to the recipient requesting the recipient to either accept or reject the order. If the recipient accepts the order, the recipient enters in their mailing address in the website, which is not disclosed to the user, and the order will then be delivered to the recipient. If the recipient rejects the order, the user's order will be cancelled and the order will not be delivered to the recipient.

### FIELD OF THE INVENTION

The present invention relates to the field of online gifts and more particularly to a method and system of the process of online gift sending.

### BACKGROUND

For internet users trying to send tangible gifts to a recipient, users must provide and enter in the recipient's mailing address into the website in order for their gift to be delivered. But not all users know the recipient's mailing address. Users who meet people online, on social network websites, match matching websites, or any kind of social interaction websites may not have any other information but only the recipient's email address. Users who want to send items to people they already know may still not have their mailing address. Users may be too busy or feel awkward to ask for people's mailing address. There are many reasons where the user may not have a person's mailing address however in order for the user to send gifts to a recipient the mailing address is required.

### SUMMARY OF THE INVENTION

The claimed method and system is for the internet user to order and send tangible items to a recipient without having to provide the recipient's mailing address and only needing to enter the recipient's email address in the website that the user is ordering from. The user can enter in the recipient's email address in the website before or after selecting their item or items, then submits the order online which upon completion an email is sent to the recipient requesting the recipient to click on a hyper-link which returns the recipient back to the website to either accept or reject the order. If the recipient accepts the order, the recipient will be prompted to enter in their mailing address in the website. All information provided by the recipient is not disclosed to the user. After the recipient enters in and submits their information, the website sends a notification to the user and recipient that the online order was accepted and the website itself is prompted with a notification to deliver the order to the recipient. If the recipient rejects the request, a notification of cancellation will be sent to both the user and recipient and the user's order gets cancelled.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are used to indicate correspondence between referenced elements.

FIG. 1 is an example of a website which uses the process of the present invention.

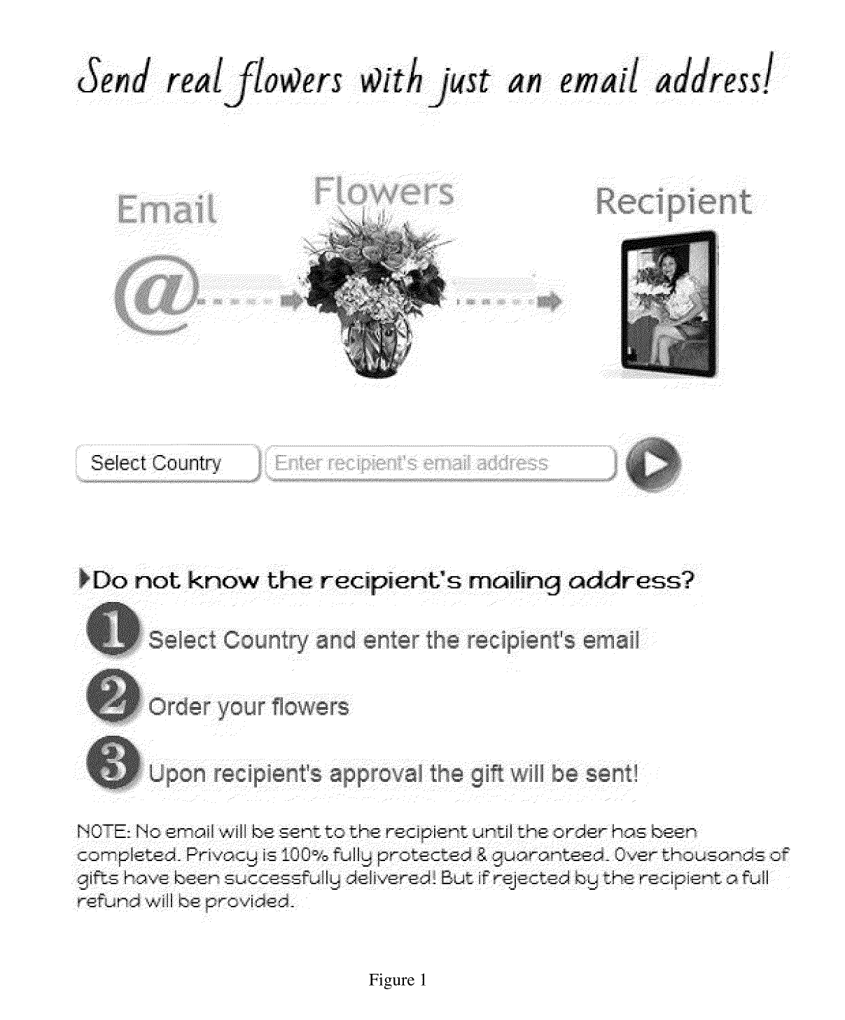

FIG. 2 is a flow chart with reference numbers illustrating the process of the present invention.

FIG. 3 is a demonstration of the information the website requests the user to enter into the website.

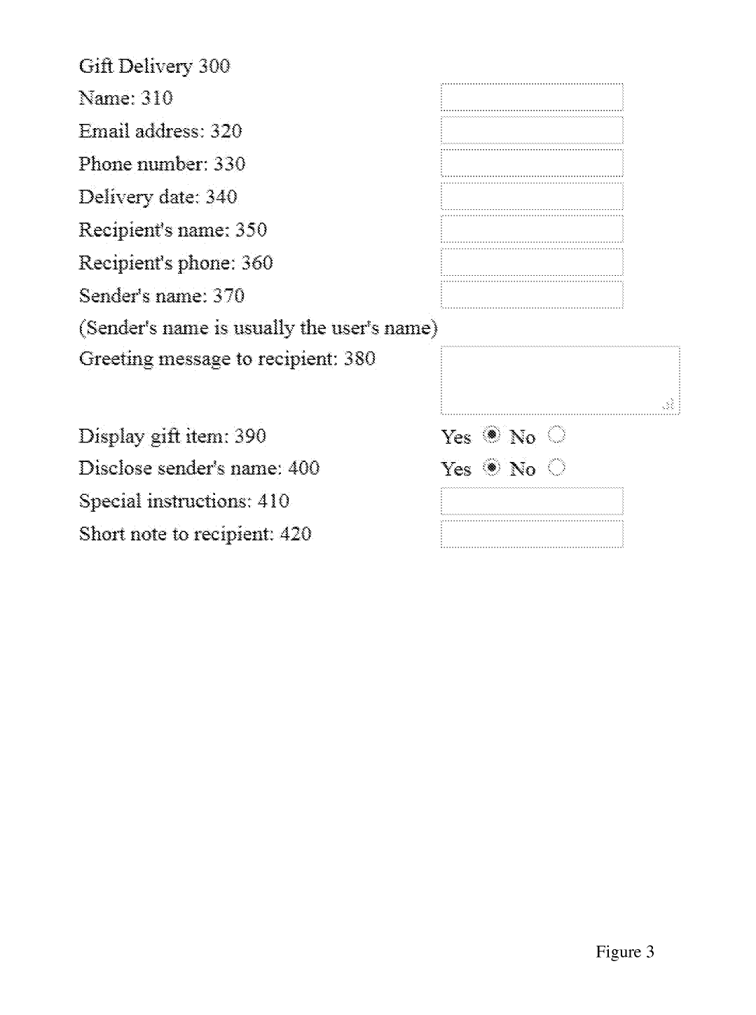

FIG. 4 is an example of the form on a website that requests information from the user.

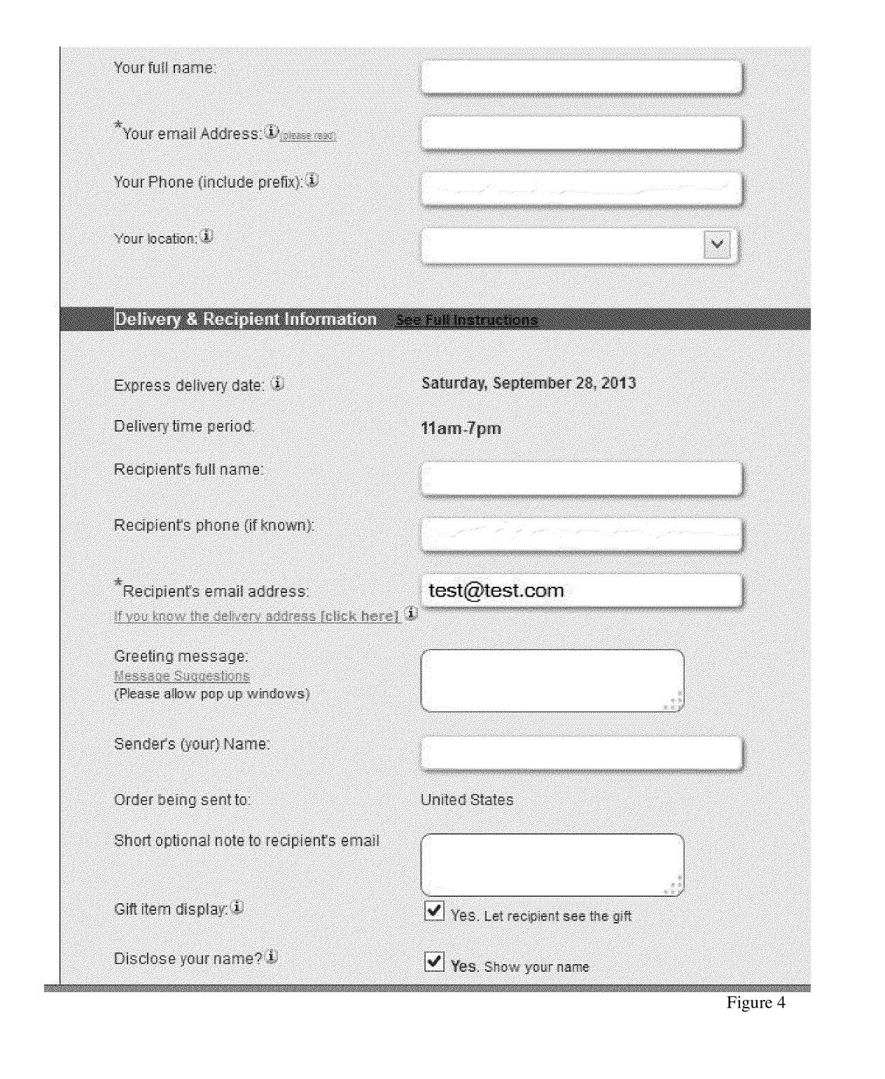

### OBJECTIVES OF THE INVENTION

The objective of the present invention is to allow the internet user to send tangible items to a recipient with the sole use of the recipient's email address.

Another objective is to provide a technique in which the information entered into the website by the recipient is not disclosed to the user which protects the recipient's privacy.

### DETAILED DESCRIPTION OF THE INVENTION

The computer-implemented system and method is for the internet user to order and send tangible items to a recipient without having to provide the recipient's mailing address and only needing to enter the recipient's email address in the website that the user is ordering from. The user can enter in the recipient's email address in the website before or after selecting their item or items, then submits the order online which upon completion an email is sent to the recipient requesting the recipient to click on a hyper-link which returns the recipient back to the website to either accept or reject the order. If the recipient accepts the order, the recipient will be prompted to enter in their mailing address in the website. The recipient's information is not disclosed to the user and protects the recipient's privacy. After the recipient enters in and submits their information, the website sends a notification to the user and recipient that the online order was accepted and the website itself is prompted with a notification to deliver the order to the recipient. If the recipient rejects the request, an email notification of cancellation will be sent to both the user and recipient and the user's order gets cancelled.

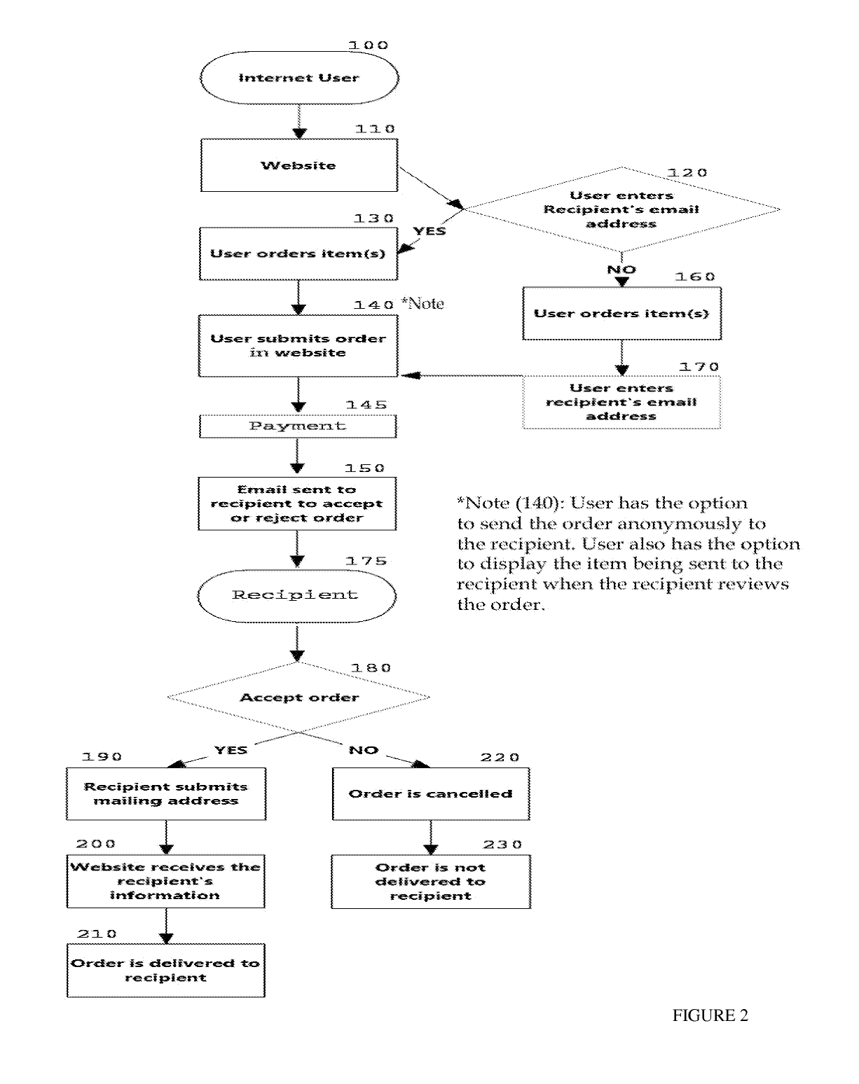

FIG. 2. illustrates a functional diagram of the process which the user 100 is able to send tangible items and gifts to the recipient 175 without providing the recipient's 175 mailing address and only the recipient's 175 email address.

This invention relates to an internet service. The current invention uses Internet communications tool, browser, ISP (Internet Service Providers), embedded web-site, URL, protocols and languages that are known to one skilled in the art and therefore not disclosed here in detail.

The User 100 accesses the website 110 and has the option to first enter the recipient's email address 120 prior to ordering any items on the website 110. When the recipient's email address 120 is entered, the user will then be directed to the website 110 to order item(s) 130. When the user 100 does not enter the recipient's email address 120, the user 100 can first order item(s) 160 then enter the recipient's email address 170.

The user 100 then submits the order in the website 140. Upon submitting the order, the user 100 has the option to display or hide their name making the order delivery anonymous when the recipient 175 views the order request from the website 100. The user 100 also has the option to show the item(s) being sent to the recipient 175 when the recipient 175 receives the request to accept the order in the website 110. In the example of the form for a Gift Delivery 300 the user 100 may be requested to enter other information including a Delivery date 340, User's name 310, User's email address 320, User's phone number 330, Recipient's name 350, Recipient's phone 360, Sender's name 370, Greeting message 380, Display gift item option 390, Disclose sender's name option 400, Special instructions 410 and a Short note to the recipient 420.

The user 100 can select a Delivery date 340 which is the date of delivery that the gift is to be delivered to the recipient 175. The User's name 310 to be entered in the form is the name of the internet user 100. The Sender's name 370 is normally the user's name however there may be cases where the user 100 and sender is different. One example is that the user 100 is an administrative secretary of a company who is ordering a gift delivery on behalf of a company which the company would be the sender. The User's email address 320 is required as the website will send email notifications to the user 100. The User's email address 320 may also be used for login purposes to view the user's account information as well as viewing the order details and order status. The User's phone number 330 may be required in the case that the user 100 needs to be reached for order problems or delivery issues. The Recipient's name 350 and Recipient's phone number 360 is not required but may be helpful in the case that the recipient does not respond to the order request and the recipient could then be contacted by phone. Not all users may know the recipient's real name or phone number. The Greeting message 380 is an option for the user 100 to give to the recipient. The Greeting message 380 is normally entered in the website 110 and later printed or written out and given to the recipient along with the user's gift order. The Display gift item 390 option is an option allowing the gift item to be displayed or not displayed on the website 110 to the recipient 175 upon when the recipient 175 clicks on the hyper link and views the order request. The user 100 may wish to send their order without showing the item to the recipient 175. The “Disclose sender's name” 400 option allows the user to disclose or not disclose their name to the recipient 175. Some recipient's may not accept the order if they do not know the sender however some user's may still wish to send their gift anonymously. The Special instructions 410 is for the user 100 to write any kind of special instructions or notes for the website 110 to read or note. The Short note to recipient 420 allows the user 110 to write a short note to the recipient 420. This note is shown after the recipient 175 clicks the hyper link and views the order request. This may be useful for the user 100 to write a note to the recipient 175 asking the recipient 175 to accept the order request. Upon accepting the request, the order will then be delivered to the recipient 175. When rejected, the order then gets cancelled and no delivery is made.

After the order is submitted, the user 100 will then be prompted to make payment 145 for the order. Payment may be in the form of but not limited to credit cards, internet payment methods, bank transfer payments, user credits, website credits, gift credits or mobile device payments. During the payment process, the user 100 may be required to enter in the user's billing information including the full name, address and phone number which this data is kept private and is not disclosed to the recipient 175.

After payment is completed an email 150 is sent to the recipient 175 which the recipient 175 will receive an email and can then accept 180 the order. When the recipient 175 accepts the order, the recipient 175 is then prompted to enter their mailing address 190 and other information of the recipient 175 including the recipient's name and phone number. The website 110 then receives the recipient's information 200 and the order is then delivered 210 to the recipient 175. When the recipient 175 does not accept the order, the order is then cancelled 220 and the order is not delivered 230 to the recipient 175.

Operation

The Internet user uses a computer or mobile device to connect to the Internet to access the website and web pages. The web and application server(s) use standard SQL queries to read and write data to a database server. Emails and email notifications are sent through the web and application servers. The technology is based on scripts and codes within the website pages allowing the user to be able to enter the recipient's email address, make a purchase and have the order delivered or cancelled based on the recipient's decision to accept or reject the order. When the recipient accepts the order, there are backend website codes and scripts that will trigger the order to send a notification to the website for the order to be processed and delivered. When the recipient rejects the order, the backend scripts will cancel the order and send email notifications to both the internet user and the recipient that the order has been cancelled.

Advantages

While sending gifts and items to recipient's is very convenient and easy to do online, not every internet user has the recipient's mailing address. Many internet users may meet other people online but not have a method to send items to the person without knowing the person's mailing address. The current invention solves this growing need for internet users to send tangible gifts and items to recipients by only providing the recipient's email address. The current invention protects the recipient's privacy by not showing the internet user the recipient's mailing address. The current invention allows the user the option to send items and gifts to the recipient anonymously. The current invention allows the user the option to show the recipient the item or items being sent prior to the recipient accepting or rejecting the delivery request. The current invention can help save money for the internet user as the recipient can reject the order before the order is ever delivered which the user would be refunded rather than the internet user having to first send the order to the recipient's mailing address when the recipient does not want the order. The current invention can also help gifts and orders to be properly delivered to the recipient since it is less likely that the recipient will make a mistake entering in their own mailing address versus the user who may not have all the correct details and enter in incorrect or missing information.

### CONCLUSION, RAMIFICATIONS, AND SCOPE

For internet users who do not have the recipient's mailing address but wish to send tangible gifts, items or orders to the recipient, the current invention solves this by creating a method and system which the internet user just needs to provide the recipient's email address. For the recipient, an email address is easier and safer to give to others than their full mailing address. Nowadays, privacy is becoming a bigger issue and the current invention helps protect both the internet user's and recipient's privacy. There are multiple advantages in the use of the current invention as stated above in the section titled Advantages.

What is claimed:

1. A system for the internet user to order and send tangible items to a recipient without having to provide the recipient's mailing address and only needing to enter the recipient's email address in the website that the user is ordering from. The user enters in the recipient's email address before or after selecting their item or items, submits the order online, an email is sent to the recipient requesting the recipient to either accept or reject the order. If the recipient accepts the order, the recipient enters in their mailing address in the website, the website sends a notification to the user and recipient that the online order was accepted, and a notification prompts the website to deliver the order to the recipient. If the recipient rejects the request, a notification of cancellation is sent to both the user and recipient and the order gets cancelled.

2. The system of claim 1, wherein said system is a computer implemented method utilizing the internet.

3. The system of claim 1, wherein the said user and recipient enters data into the website through the use of an electronic device, computer, tablet or mobile device.

4. The system of claim 1, wherein the email that is sent to said recipient comprises a hyper-link that the recipient clicks on to be redirected back to the website for the recipient to select the option to either accept or reject the user's order.

5. The system of claim 1, wherein said recipient's mailing address is a shipping, postal address or any form of a physical address.

6. The system of claim 1, wherein the recipient's mailing address and information is stored in the website's database and is not shown or disclosed to the user without permission of the recipient.

7. The system of claim 1, wherein the user has the option to disclose or not disclose the user's name to the recipient making the user's order anonymous.

8. The system of claim 1, wherein the user has the option to allow the website to show the recipient the item or items being sent.

9. The system of claim 1, wherein the user has the option to write a note to the recipient before the recipient decides to accept or reject the user's order.

10. The system of claim 1, wherein the recipient has the option to write a note to said user upon accepting or rejecting the order.

11. The system of claim 1, wherein the recipient's rejection of the user's said order, the user will be provided a refund or credit by the website.

12. The system of claim 1, wherein the user has the option to enter the recipient's phone number in substitution of the email address.

13. The method of claim 12, wherein said phone number corresponds directly with the recipient's email address.
